(19) United States
(12) Patent Application Publication
(10) Pub. No.: US 2012/0054815 A1
(43) Pub. Date: Mar. 1, 2012

(54) VIDEO DISPLAY APPARATUS AND VIDEO DISPLAY METHOD

(75) Inventor: Chikara USHIMARU, Tokyo (JP)

(73) Assignee: Kabushiki Kaisha Toshiba, Tokyo (JP)

(21) Appl. No.: 13/104,944

(22) Filed: May 10, 2011

(30) Foreign Application Priority Data
Aug. 30, 2010 (JP) 2010-192740

(51) Int. Cl. H04N 7/173

(52) U.S. Cl. 725/112

(57) ABSTRACT

According to one embodiment, there is provided a video display apparatus, including: a display controller configured to cause a display module to display a moving image distributed from a video hosting site, the moving image having a first URI; and a URI output module configured to output a second URI different from the first URI, upon receiving a URI transmission request during display of the moving image.

### CROSS-REFERENCE TO RELATED APPLICATION(S)

This application is based upon and claims the benefit of priority from Japanese Patent Application No. 2010-192740, filed on Aug. 30, 2010 the entire contents of which are incorporated herein by reference.

### FIELD

Embodiments described herein relate generally to a video display apparatus which receives a moving image distributed from a video hosting service or the like and displaying (reproducing) the moving image on a display module.

### BACKGROUND

Presently, it becomes common to receive a moving image distributed from a video hosting service and to display (reproduce) the moving image on a personal computer (PC) or the like, with the spread of the Internet.

Further, there is a demand for using the video hosting service on a television (TV) as well as on the PC.

On the TV, an on-screen keyboard or a remote controller is generally used to perform a write operation such as character entry into a video hosting site providing a hosting service similar to that for a PC and so on.

However, it may be troublesome for the user to perform the write operation using such an on-screen keyboard or such a remote controller, as compared with the case where a PC keyboard or the like is used.

That is, while there is a demand for using a video hosting service on a TV as well as on a PC, it is troublesome to perform a write operation concerning a moving image in a video hosting site with the TV.

### BRIEF DESCRIPTION OF DRAWINGS

A general architecture that implements the various feature of the present invention will now be described with reference to the drawings. The drawings and the associated descriptions are provided to illustrate embodiments and not to limit the scope of the present invention.

FIG. 1 illustrates an example of a video hosting service using a video display apparatus according to an embodiment.

FIGS. 2A and 2B illustrate an example of a screen displayed when a control apparatus (PC) receives a URI of a video hosting site concerning a first moving image according to the embodiment.

FIGS. 3A to 3D illustrate display screens in the video display apparatus according to the embodiment when a URI of a video hosting site concerning a moving image (first moving image) is received and when a URI of a video hosting site concerning a relevant moving image (second moving image) which relates to the moving image (first moving image) is received.

FIG. 4 illustrates a system configuration of the video display apparatus according to the embodiment.

FIG. 5 illustrates a system operation flow in the video hosting service using the video display apparatus according to the embodiment.

FIG. 6 illustrates the first half of processing in the video display apparatus according to the embodiment.

FIG. 7 illustrates the second half of the processing in the video display apparatus according to the embodiment.

FIG. 8 illustrates examples of MIME types in URIs.

FIG. 9 illustrates another example of a video hosting service using the video display apparatus according to the embodiment.

FIGS. 10A and 10B illustrate another example of a screen to be displayed when the control apparatus (PC) receives the URI of the video hosting site concerning the first moving image according to the embodiment.

### DETAILED DESCRIPTION

In general, according to one embodiment, there is provided a video display apparatus, including: a display controller configured to cause a display module to display a moving image distributed from a video hosting site, the moving image having a first URI; and a URI output module configured to output a second URI different from the first URI, upon receiving a URI transmission request during display of the moving image.

For example, in a video hosting service, moving images (video contents) submitted to a server on the Internet by a large number of unspecified users can be shared and viewed by the large number of unspecified users.

In this embodiment, moving images distributed by the video hosting service are referred to as shared moving images or moving images. In addition, shared moving images relevant to a shared moving image are referred to as relevant shared moving images or relevant moving images.

In addition, a video hosting site is generally arranged to allow users not to gain direct access to each moving image (video content) but to first gain access to a URI (Uniform Resource Identifier) of a web site (web page) including the moving image and then reproduce the moving image acquired from the URI.

In addition, the video hosting site provides many functions as well as a function of providing moving images. For example, the video hosting site allows each viewer to write a comment on a reproduced moving image, to give rating to the moving image, to recommend the moving image to acquaintances, or to save the moving image.

For example, a personal computer (PC) having a keyboard or the like is suitable for the video hosting service because the aforementioned operation for writing a comment can be performed comparatively easily on the PC.

There is a demand for using the video hosting service on a television (TV) as well as on the personal computer (PC). However, for example, when a user wants to perform a write operation concerning a moving image on the video hosting site, the user must use a remote controller or the like of the television (TV). That is troublesome for the user.

The embodiment will be described below with reference to the drawings.

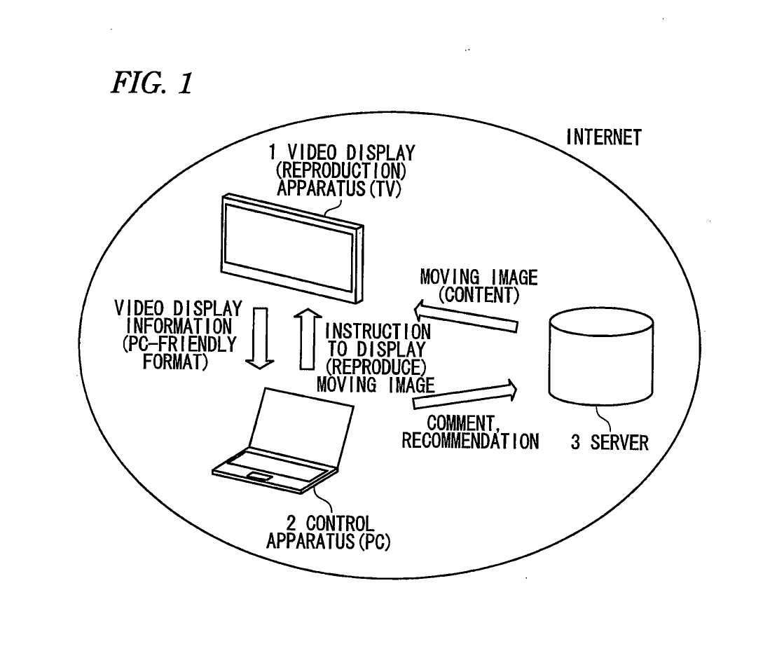

FIG. 1 illustrates an example of a video hosting service using a video display apparatus according to the embodiment.

The reference numeral 1 represents a video display (reproduction) apparatus (TV); 2, a control apparatus (PC); and 3, a server.

In this embodiment, the video display (reproduction) apparatus 1 receives a TV broadcast and displays a broadcast program. The video display (reproduction) apparatus 1 also displays a shared moving image. The control apparatus 2 is a personal computer (PC). The server 3 is, for example, a server providing a streaming server function.

As shown in FIG. 1, each of the video display (reproduction) apparatus (TV) 1, the control apparatus (PC) 2 and the server 3 has a function of making a connection to the Internet, by which function the video display (reproduction) apparatus (TV) 1, the control apparatus (PC) 2 and the server 3 are connected to one another through the Internet.

In this embodiment, as an example of a use mode of a video hosting service, first, a user operates an operation portion (such as a keyboard) of the control apparatus (PC) 2 to make a connection to the Internet and gain access to a desired video hosting site.

The control apparatus (PC) 2 displays, on a video display module of the control apparatus (PC) 2, a shared moving image (video content) placed on the accessed video hosting site.

After that, the user views the shared moving image (video content) on the video display apparatus (reproduction apparatus) 1.

The user operates the control apparatus (PC) 2 and transmits an instruction to the video display apparatus (reproduction apparatus) 1 so as to display (reproduce) on the video display apparatus (reproduction apparatus) 1 the shared moving image (video content) which is being displayed on the video display module of the control apparatus (PC) 2.

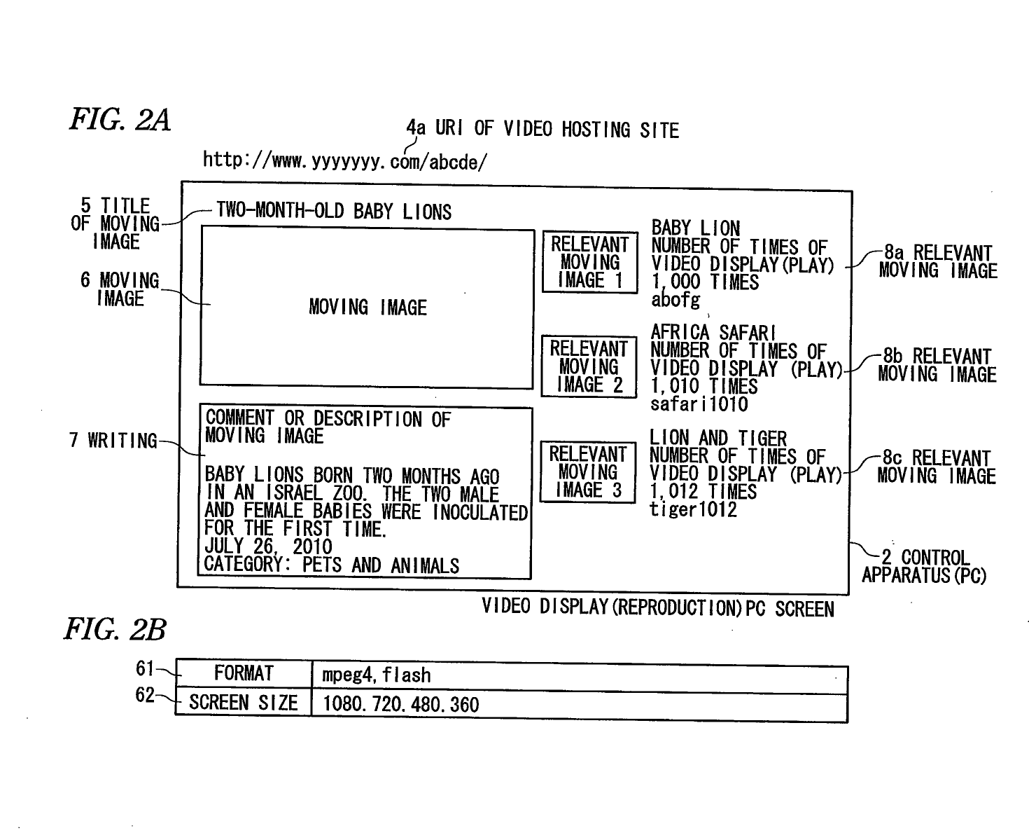

On this occasion, the control apparatus 2 transmits, to the video display apparatus (reproduction apparatus) 1, a URI (for example, “http://www.yyyyyyy.com/abcde/” shown in FIG. 2A) of a page introducing a video content in the video hosting site having the shared moving image (video content) which is being displayed, as will be described later.

On receiving the reproduction instruction transmitted from the control apparatus 2, the video display apparatus (reproduction apparatus) 1 gives the server 3 an instruction to distribute, to the video display apparatus (reproduction apparatus) 1, the shared moving image which is being displayed on the control apparatus 2.

That is, the video display apparatus (reproduction apparatus) 1 obtains a URI of a video content with a most suitable combination to be displayed on the video display apparatus (reproduction apparatus) 1, from the MIME type of the URI (“http://www.yyyyyyy.com/abcde/” in this case) of the page introducing a video content in the specified video hosting site.

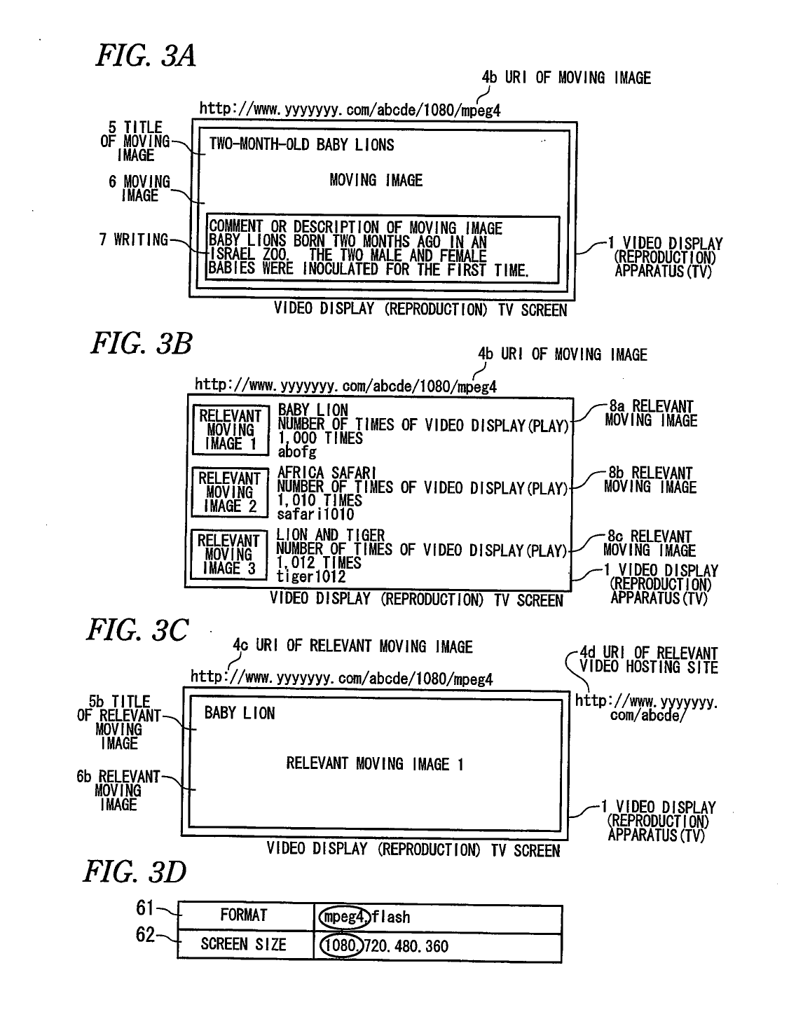

Here, the video display apparatus (reproduction apparatus) 1 analyzes data (for example, described in HTML format) obtained by access to the URI (“http://www.yyyyyyy.com/abcde/” shown in FIG. 2A) of the page introducing the video content, and obtains “http://www.yyyyyyy.com/abcde/1080/mpeg4” shown in FIG. 3A. The video display apparatus (reproduction apparatus) 1 then gives a distribution instruction to the server 3.

When the URI of the video content is obtained, for example, an item list (for example, described in XML format) for the video content included in the page introducing the video content is acquired. Here, assume that information including resolution, format, title name, URI, etc. are described for each item in the item list.

The video display apparatus (reproduction apparatus) 1 selects each item the most suitable for display, from these pieces of information, and obtains a URI (“http://www.yyyyyyy.com/abcde/1080/mpeg4” in this case) of the video content based on the selected item.

On receiving the video distribution instruction transmitted from the video display apparatus (reproduction apparatus) 1, the server 3 distributes, to the video display apparatus (reproduction apparatus) 1, the video content of the specified URI (“http://www.yyyyyyy.com/abcde/1080/mpeg4” in this case).

The video display apparatus (reproduction apparatus) receives the video content (whose URI is “http://www.yyyyyyy.com/abcde/1080/mpeg4” in this case) distributed from the server 3, and displays the video content on the video display module of the video display apparatus (reproduction apparatus) 1.

In addition, when a video content in the page introducing the video content displayed on the control apparatus 2 is displayed on the video display module of the video display apparatus (reproduction apparatus) 1, reproduction (including reproduction, stop, fast-forward, rewind, etc.) of this shared moving image can be controlled by the video display apparatus (reproduction apparatus) 1.

Here, when the display of the shared moving image is moved from the control apparatus 2 to the video display apparatus (reproduction apparatus) 1, the control of the moving image is also moved to the video display apparatus (reproduction apparatus) 1 side in connection therewith. After that, the reproduction of the shared moving image can be controlled on the video display apparatus (reproduction apparatus) 1 side.

In addition, the user can operate the video display apparatus (reproduction apparatus) 1 not only to control the reproduction (including reproduction, stop, fast-forward, rewind, etc.) of the shared moving image but also to perform a write operation on the shared moving image.

As described above, in the video display apparatus (reproduction apparatus) 1, the user uses a TV remote controller or the like to operate the video display apparatus (reproduction apparatus) 1.

It is convenient that the reproduction (including reproduction, stop, fast-forward, rewind, etc.) of the shared moving image can be controlled comparatively easily by use of the TV remote controller or the like.

However, characters must be inputted for the write operation on the shared moving image. The write operation becomes complicated when the TV remote controller or the like is used. Improvement in terms of user-friendliness is desired by users.

In this embodiment, therefore, the write operation on the shared moving image is performed using the control apparatus (PC) 2.

On this occasion, the video display apparatus (reproduction apparatus) 1 transmits, to the control apparatus (PC) 2, the URI (“http://www.yyyyyyy.com/abcde/”) of the page introducing the video content of the shared moving image which is being displayed.

That is, in this embodiment, the URI (“http://www.yyyyyyy.com/abcde/1080/mpeg4”) of the shared moving image which is being displayed is not transmitted, but a different URI from the URI of the shared moving image which is being displayed, that is, for example, the URI (“http://www.yyyyyyy.com/abcde/” in this case) of the page introducing a moving image in the video hosting site including the shared moving image (video content) which is being displayed, is transmitted.

A comment or the like on the shared moving image is written into the server 3 not from the video display apparatus (reproduction apparatus) 1 but from the control apparatus (PC) 2.

FIGS. 2A and 2B illustrate an example of a display screen when the URI of the video hosting site concerning the shared moving image (first moving image) is received by the control apparatus (PC) according to the embodiment.

As described above, in this embodiment, the video hosting site concerning the moving image (first moving image) is first received by the control apparatus (PC), and the control of reproduction of the moving image (first moving image) is then moved to the video display apparatus (reproduction apparatus) 1. Here, description will be made on display when the video hosting site concerning the moving image (first moving image) is received by the control apparatus (PC).

FIG. 2A is a view showing a display screen of the control apparatus (PC) 2.

The reference numeral 2 represents the control apparatus (PC). Here, a video display module (video display (reproduction) PC screen) of the control apparatus (PC) 2 is depicted.

The reference numeral 4a represents a URI of a video hosting site. In the control apparatus (PC) 2, information about a page introducing a video content in the video hosting site, which information is distributed from the server 3, is first acquired using the URI of the video hosting site. At the same time, a moving image, a relevant moving image, a comment, etc. are acquired in types (such as format and screen size) suitable to the control apparatus (PC) 2. These are arranged on one display screen and displayed on the video display module of the control apparatus (PC) 2.

Here, the URI of the page introducing a video content in the video hosting site is, for example, “http://www.yyyyyyy.com/abcde/”.

The reference numeral 5 represents a title of the moving image distributed in the video hosting site. Here, the title of the moving image is “two-month-old baby lions”.

The reference numeral 6 represents a moving image distributed by the video hosting site. The reference numeral 7 represents a writing or the like about the moving image. A comment or description of the moving image is written here. Here, the writing 7 is “Baby lions born two months ago in an Israel zoo. The two male and female babies were inoculated for the first time. Jul. 26, 2010 Category: Pets and Animals”.

The reference numeral 8a represents information distributed in a relevant video hosting site. As described above, a relevant moving image is a moving image relevant to the moving image distributed by the video hosting site. Here, the moving image distributed by the relevant video hosting site is a relevant moving image 1. The title is “baby lion”. In addition, the display here includes the number of times of video display (play) 1,000 times and “abcfg” which is the URI of the relevant video hosting site expressed in an abbreviated form of the absolute address “http://www.yyyyyyy.com/abcfg/”.

Likewise, the reference numeral 8b represents information distributed in a relevant video hosting site. As described above, a relevant moving image is a moving image relevant to the moving image distributed by the video hosting site. Here, the moving image distributed by the relevant video hosting site is a relevant moving image 2. The title is “Africa Safari”. In addition, the display here includes the number of times of video display (play) 1,010 times and “safari1010” which is the URI of the relevant video hosting site expressed in an abbreviated form of the absolute address in the same manner as above mentioned.

Likewise, the reference numeral 8c represents information distributed in a relevant video hosting site. As described above, a relevant moving image is a moving image relevant to the moving image distributed by the video hosting site. Here, the moving image distributed by the relevant video hosting site is a relevant moving image 3. The title is “Lion and Tiger”. In addition, the display here includes the number of times of video display (play) 1,012 times and “tiger1012” which is the URI of the relevant video hosting site expressed in an abbreviated form of the absolute address in the same manner as above mentioned.

FIG. 2B illustrates plural formats with which moving images can be transmitted from the video hosting site.

Here, the video display apparatus (reproduction apparatus) 1 can select a format 61 and a screen size 62 in accordance with the reception-side performance.

For example, in the video hosting site, the format 61 for transmission can be selected from “mpeg4” and “flash”. On the other hand, the screen size 62 for transmission can be selected from “1080”, “720”, “480” and “360”.

FIGS. 3A to 3D illustrate display screens in the video display apparatus according to the embodiment when the URI (“http://www.yyyyyyy.com/abcde/” in this case) of the video hosting site concerning the moving image (first moving image) is received and when the URI (“http://www.yyyyyyy.com/abcfg/”) of the video hosting site concerning the relevant moving image (second moving image) which is a moving image relevant to the moving image (first moving image) is received.

As described above, in this embodiment, the video hosting site concerning the moving image (first moving image) is received by the control apparatus (PC) 2, and the control of the moving image (first moving image) is then moved to the video display apparatus (reproduction apparatus) 1. Here, description will be made on display when the control of the moving image (first moving image) is moved to the video display apparatus (reproduction apparatus) 1.

As shown in FIGS. 3A-3D, the display form of a moving image and so on in the video display apparatus (reproduction apparatus) 1 according to the embodiment differs from that in the control apparatus (PC) 2.

FIG. 3A is a view showing a display screen of the video display apparatus (reproduction apparatus) 1.

The reference numeral 1 represents the video display apparatus (reproduction apparatus). Here, a video display module (video display (reproduction) TV screen) of the video display apparatus (reproduction apparatus) 1 is depicted.

The reference numeral 4b represents a URI of a moving image. The URI 4b is expressed as “http://www.yyyyyyy.com/abcde/1080/mpeg4”.

On receiving “http://www.yyyyyyy.com/abcde/” expressing the URI of the video hosting site in the same manner as above mentioned, the video display apparatus (reproduction apparatus) 1 first decides a suitable format and a suitable screen size in accordance with the video display capability etc. of the video display apparatus (reproduction apparatus) 1 itself so that the video display apparatus (reproduction apparatus) 1 can make a fine video display.

Based on the decided format and screen size, the video display apparatus (reproduction apparatus) 1 obtains a URI of the video content with a most suitable combination to be displayed on the video display apparatus (reproduction apparatus) 1 from the MIME type of the URI (“http://www.yyyyyyy.com/abcde/” in this case) of the page introducing the video content in the specified video hosting site.

The video display apparatus (reproduction apparatus) analyzes data (for example, described in HTML format) obtained by access to the URI (“http://www.yyyyyyy.com/abcde/” shown in FIG. 2A) of the page introducing the video content, and obtains “http://www.yyyyyyy.com/abcde/1080/mpeg4/” shown in FIG. 3A.

Based on the obtained URI (“http://www.yyyyyyy.com/abcde/1080/mpeg4/”) of the video content, a suitable moving image is acquired from the server 3. The moving image is displayed on the display module of the video display apparatus (reproduction apparatus) 1.

FIG. 3D illustrates plural formats with which moving images can be transmitted from the video hosting site.

Here, the format 61 and the screen size 62 suitable to the video display apparatus (reproduction apparatus) 1 are decided as “mpeg4” and “1080” respectively, as described above.

In the embodiment, a shared moving image is acquired based on the format 61 and the screen size 62 (that is, the format 61 is “mpeg4” and the screen size 62 is “1080”) decided in the video display apparatus (reproduction apparatus) 1, and displayed on the video display module.

In addition, in the embodiment, a display concerning a shared moving image (moving image) and a display concerning relevant moving images are not arranged together on one screen. Video display is controlled by the video display apparatus (reproduction apparatus) 1 to make the display concerning the shared moving image (moving image) and the display concerning the relevant moving images on different screens.

Next, description will be made on an example of the display form of a shared moving image and relevant moving images.

FIG. 3A shows a display concerning a shared moving image (moving image) displayed on the video display module of the video display (reproduction) apparatus (TV) 1. Here, only the display concerning the shared moving image is made.

The reference numeral 5 represents a title of the shared moving image (moving image) distributed in this video hosting site. The URI of the page introducing the moving image in the video hosting site is “http://www.yyyyyyy.com/abcde/”.

Here, the title of the moving image is “two-month-old baby lions”.

The reference numeral 6 represents the shared moving image (moving image) distributed in the video hosting site. The reference numeral 7 represents a writing in which a comment or description about the shared moving image (moving image) 6 is written here. Here, the writing 7 is “Baby lions born two months ago in an Israel zoo. The two male and female babies were inoculated for the first time. Jul. 26, 2010 Category: Pets and Animals”.

FIG. 3B shows a display concerning relevant moving images, that is, a display screen concerning shared moving images relevant to the aforementioned shared moving image (moving image) 6. These are also displayed on the video display module of the video display (reproduction) apparatus (TV) 1.

As described above, in the video display apparatus (reproduction apparatus) 1 in the embodiment, the display concerning the relevant moving images (relevant shared moving images) is made on a different screen from the display concerning the shared moving image (moving image).

Also here, the reference numeral 8a represents information distributed in a relevant video hosting site acquired thus. A relevant moving image 1 is a relevant moving image distributed by the relevant video hosting site. The title is “baby lion”. In addition, the display here includes the number of times of video display (play) 1,000 times and “abcfg” which is the URI of the relevant video hosting site expressed in an abbreviated form.

Likewise, the reference numeral 8b represents information distributed in a relevant video hosting site. The moving image distributed by the relevant video hosting site is a relevant moving image 2. The title is “Africa Safari”. In addition, the display includes the number of times of video display (play) 1,010 times and “safari1010” which is the URI of the relevant video hosting site expressed in an abbreviated form.

Likewise, the reference numeral 8c represents information distributed in a relevant video hosting site. The moving image distributed by the relevant video hosting site is a relevant moving image 3. The title is “Lion and Tiger”. In addition, the display screen includes the number of times of video display (play) 1,012 times and “tiger1012” which is the URI of the relevant video hosting site expressed in an abbreviated form.

FIG. 3C is a view showing an example of a display, for example, when a user operates the remote controller 18 or the like of the video display (reproduction) apparatus (TV) 1 to select the relevant moving image 1 from the aforementioned relevant moving images shown in FIG. 3B.

The operation to select the relevant moving image 1 can be performed easily using the remote controller 18.

The moving image is displayed on the video display module (video display (reproduction) TV screen) of the video display apparatus (reproduction apparatus) 1.

The reference numeral 5b represents the title of the shared moving image (moving image) distributed in the relevant video hosting site. Here, the title of the moving image is “baby lion”.

The reference numeral 6b represents the shared moving image (moving image) distributed by the relevant video hosting site. That is, the “relevant moving image 1” is displayed there. No comment or description on the relevant moving image (moving image) 6b is displayed here. If there is a writing, the writing may be displayed as described above.

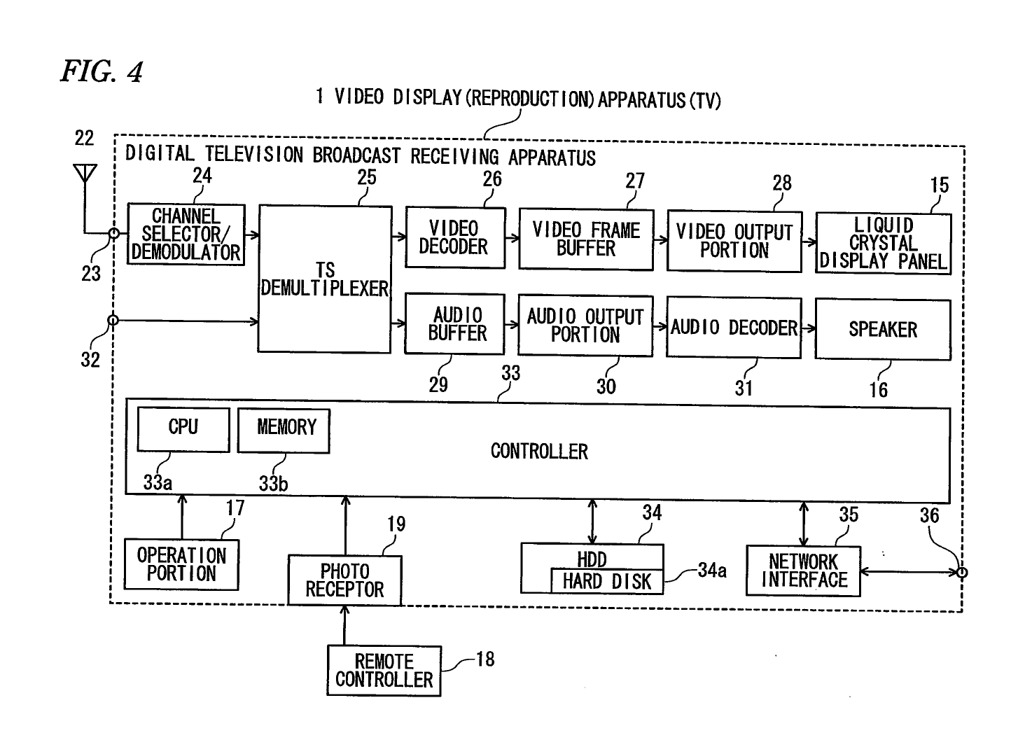

FIG. 4 illustrates a system configuration of the video display (reproduction) apparatus (TV) 1 according to the embodiment.

The reference numeral 22 represent an antenna; 23, an input terminal; 24, a channel selector/demodulator; 25, a TS demultiplexer; 26, a video decoder; 27, a video frame buffer; 28, a video output portion; 29, an audio buffer; 30, an audio output portion; 31, an audio decoder; and 32, an input terminal.

The reference numeral 33 represents a controller; 33a, a CPU; 33b, a memory; 34, an HDD; 34a, a hard disk; 35, a network interface; and 36, an input/output terminal.

A digital television broadcast signal received in the antenna 22 is supplied to the channel selector/demodulator 24 through the input terminal 23. The channel selector/demodulator 24 selects a signal of a desired channel from the inputted digital television broadcast signal, and performs a demodulation process on the selected broadcast signal to generate a TS (Transport Stream) and output the TS.

The TS outputted from the channel selector/demodulator 24 is supplied to the TS demultiplexer 25, and demultiplexed into a video component and an audio component. Of those components, the video component is subjected to a decoding process by the video decoder 26 so as to be decoded to an original digital video signal, which is stored into the video frame buffer 27.

The video signal stored in the video frame buffer 27 is read out by the video output portion 28 frame by frame, and subjected to a predetermined signal process. After that, the video signal is supplied to a liquid crystal display panel 15, where the video signal is displayed as a video image.

On the other hand, the audio component demultiplexed by the TS demultiplexer 25 is stored in the audio buffer 29, and then read out by the audio output portion 30 so as to be subjected to a predetermined signal process. Then, the audio component outputted from the audio output portion 30 is subjected to a decoding process by the audio decoder 31 so as to be decoded to digital audio data. After that, the digital audio data is converted into analog audio data, with which sound is reproduced by a speaker 16.

In addition, the video display (reproduction) apparatus (TV) 1 has an input terminal 32. A TS which is outputted from an external recording/reproducing apparatus is supplied to the input terminal 32. For example, the external recording/reproducing apparatus is an optical disk recording/reproducing apparatus for performing recording/reproducing on an optical disk such as a DVD (Digital Versatile Disk), or an external HDD (Hard Disk Drive)

The TS supplied to the input terminal 32 is supplied to the TS demultiplexer 25. The TS demultiplexer 25 operates to select one of the TS supplied from the channel selector/demodulator 24 and the TS supplied from the input terminal 32 and demultiplex the selected TS into a video component and an audio component.

Here, various operations of the video display (reproduction) apparatus (TV) 1, including the aforementioned various receiving operations, are controlled by the controller 33.

The controller 33 includes the CPU (Central Processing Unit) 33a. On receiving operation information from an operation portion 17 or operation information transmitted from the remote controller 18 and received by a photo receptor 19, the controller 33 controls each portion to reflect contents of the operation information.

The controller 33 uses the memory 33b. The memory 33b includes a ROM (Read Only Memory) storing a control program to be executed by the CPU 33a, a RAM (Random Access Memory) for providing a working area for the CPU 33a, and a nonvolatile memory storing various setting information and control information, etc.

Information about the video display capability (for example, decodable video format or displayable screen size) of the video display apparatus (reproduction apparatus) 1 is also stored in the memory 33b.

On receiving the URI (“http://www.yyyyyyy.com/abcde/”) of the page introducing the video content in the video hosting site as described above, the video display apparatus (reproduction apparatus) 1 decides a suitable format and a suitable screen size under the control of the controller 33, so as to be able to make a fine video display using the video display capability of the video display apparatus (reproduction apparatus) 1 itself or the like stored in the memory 33b.

Based on the decided format and screen size, a URI (http://www.yyyyyyy.com/abcde/1080/mpeg4 in this case) of a video content is obtained. Based on the obtained URI of the video content, a suitable moving image is acquired from the server 3 and displayed on the display module of the video display apparatus (reproduction apparatus) 1.

In addition, the controller 33 is, for example, connected to the HDD 34 which is a built-in type. Based on user's operation, the controller 33 can apply an encryption process or a conversion process to a predetermined recording format to a digital video or audio signal obtained from the video decoder 26 or the audio decoder 31, and then supply the processed video or audio signal to the HDD 34 so as to record the processed video or audio signal into the hard disk 34a.

In addition, based on user's operation, the controller 33 can make the HDD 34 read out a desired video or audio signal from the hard disk 34a, apply a decryption process thereon and then supply the decrypted video or audio signal to the video frame buffer 27 or the audio decoder 31 so as to devote the video or audio signal to video display or audio reproduction.

Further, the controller 33 is, for example, connected to a network such as the Internet through the network interface 35 and the input/output terminal 36.

Thus, based on user's operation, the controller 33 can gain access to a server on the network to acquire a desired video or audio signal so as to devote the video or audio signal to video display or audio reproduction or to record the video or audio signal into the hard disk 34a of the HDD 34.

In addition, the video display (reproduction) apparatus (TV) 1 is connected to the control apparatus (PC) 2 and the server 3 through the Internet as described above.

The video output portion 28 applies a frame double-speed conversion process on the video signal supplied frame by frame from the video frame buffer 27 so as to make it possible to display the video signal on the liquid crystal display panel 15. After that, the video output portion 28 supplies the video signal to the liquid crystal display panel 15, where the video signal is displayed as a video image.

The video output portion 28 outputs, to the liquid crystal display panel 15, the video signal supplied frame by frame from the video frame buffer 27, so as to devote the video signal to video display.

In addition, in this embodiment, the video display apparatus (reproduction apparatus) 1 is provided with a DMR function of DLNA, so that the URI (“http://www.yyyyyyy.com/abcde/” in this case) or metadata of the page introducing the shared moving image which is being displayed (reproduced) can be opened as information accompanying the moving image to the control apparatus (PC) 2. In addition, these pieces of information can be recorded in the memory 33b.

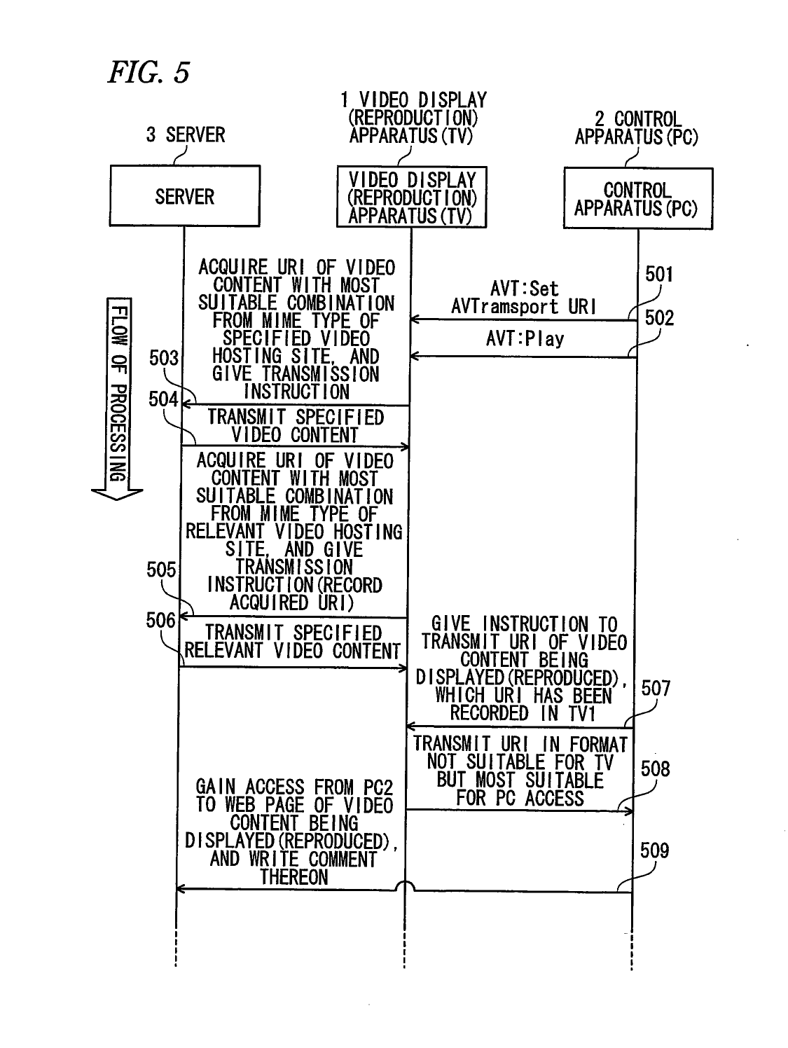

FIG. 5 illustrates a system operation flow of a video hosting service using the video display apparatus according to the embodiment.

As described above, in this embodiment, each of the video display (reproduction) apparatus (TV) 1, the control apparatus (PC) 2 and the server 3 has a function of connecting to the Internet. The video display (reproduction) apparatus (TV) 1, the control apparatus (PC) 2 and the server 3 are connected to one another through the Internet.

In this embodiment, as described above, the user first operates the control apparatus (PC) 2 to gain access to a desired video hosting site and display a shared moving image. On this occasion, the shared moving image is displayed on the display module of the control apparatus (PC) 2.

After that, the user operates to display the shared moving image on the video display (reproduction) apparatus (TV) 1.

Though not shown especially, specifically, the user operates the keyboard of the control apparatus (PC) 2 to send, from the control apparatus (PC) 2 to the video display (reproduction) apparatus (TV) 1, the URI (“http://www.yyyyyyy.com/abcde/” in this case) of the page introducing the currently viewed video content in the video hosting site. On this occasion, the URI having the MIME type indicating the video hosting site is sent.

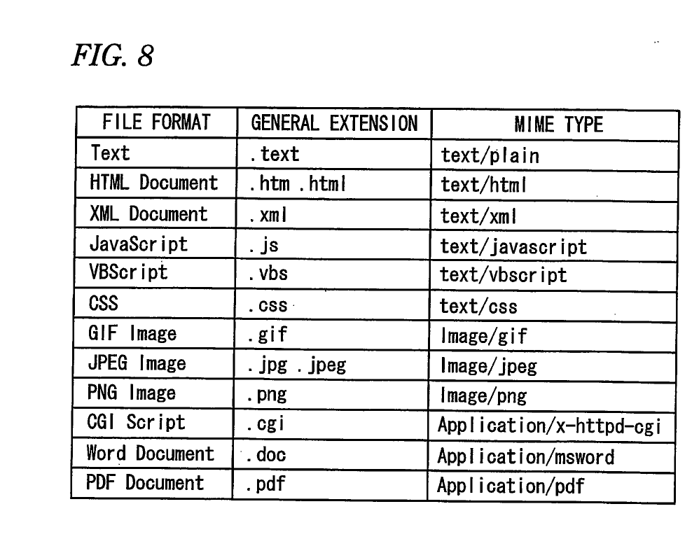

FIG. 8 illustrates examples of MIME types in URIs.

As described above, in this embodiment, the URI of the page introducing the video content in the video hosting site is “http://www.yyyyyyy.com/abcde/”, and the MIME type of the URI indicates the video hosting site.

In addition, based on the sent URI, an instruction is given to reproduce (display) the video hosting site, which is being viewed on the control apparatus (PC) 2, on the video display (reproduction) apparatus (TV) 1.

The reference numeral 501 represents a step of sending, from the control apparatus (PC) 2 to the video display (reproduction) apparatus (TV) 1, the URI of the video hosting site which is being viewed. On this occasion, a command supplied from the control apparatus (PC) 2 to the video display (reproduction) apparatus (TV) 1 is, for example, “AVT: Set AVTransport URI”.

The reference numeral 502 represents a step of giving the video display (reproduction) apparatus (TV) 1 an instruction to reproduce (display) the moving image which has been reproduced (displayed) on the control apparatus (PC) 2. A command outputted here is, for example, “AVT: Play”.

In this embodiment, the URI of the video hosting site received from the control apparatus (PC) 2 by the video display (reproduction) apparatus (TV) 1 is an MIME type indicating the video hosting site. The URI is, for example, “http://www.yyyyyyy.com/abcde/”.

That is, as described above, the video display apparatus (reproduction apparatus) 1 obtains a URI of a video content with a most suitable combination to be displayed on the video display apparatus (reproduction apparatus) 1 based on the MIME type of the URI (“http://www.yyyyyyy.com/abcde/” in this case) of the page introducing the video content in the specified video hosting site.

That is, here, the video display apparatus (reproduction apparatus) 1 analyzes data (for example, described in HTML format) obtained by access to the URI (“http://www.yyyyyyy.com/abcde/” shown in FIG. 2A) of the page introducing the video content, and obtains “http://www.yyyyyyy.com/abcde/1080/mpeg4” shown in FIG. 3A. Then, the video display apparatus (reproduction apparatus) 1 gives the server 3 a distribution instruction.

When the URI of the video content is obtained, an item list (for example, described in XML format) for the video content included in the page introducing the video content is, for example, acquired. Here, assume that information about resolution, format, title name, URI, etc. are described for each item in the item list.

The video display apparatus (reproduction apparatus) 1 selects each item the most suitable for display, from these pieces of information, and obtains a URI (“http://www.yyyyyyy.com/abcde/1080/mpeg4” in this case) of the video content based on the selected item.

In this embodiment, as shown in FIG. 3D, for example, kinds of formats are “mpeg4” and “flash”. On the other hand, kinds of screen sizes are “1080”, “720”, “480” and “360”.

As described above, information about the video display capability (for example, decodable video format and displayable screen size) of the video display apparatus (reproduction apparatus) 1 is also stored in the memory 33b of the video display (reproduction) apparatus (TV) 1.

On receiving the URI (“http://www.yyyyyyy.com/abcde/”) of the page introducing the video content in the video hosting site as described above, the video display apparatus (reproduction apparatus) 1 decides a suitable format and a suitable screen size under the control of the controller 33, so as to be able to make a fine video display using the video display capability or the like of the video display apparatus (reproduction apparatus) 1 itself stored in the memory 33b.

Based on the decided format and screen size, the URI (“http://www.yyyyyyy.com/abcde/”) of the page introducing the video content in the video hosting site is obtained in the controller 33. Based on the obtained URI (“http://www.yyyyyyy.com/abcde/”) of the page introducing the video content in the video hosting site, a URI (“http://www.yyyyyyy.com/abcde/1080/mpeg4”) of a suitable moving image for the video display apparatus (reproduction apparatus) 1 is acquired from the server 3, and the moving image is displayed on the display module of the video display apparatus (reproduction apparatus) 1.

That is, as described above, the video display (reproduction) apparatus (TV) 1 gives the server 3 an instruction to transmit a moving image corresponding to the obtained URI (“http://www.yyyyyyy.com/abcde/1080/mpeg4”).

The reference numeral 503 represents a step of obtaining a URI (“http://www.yyyyyyy.com/abcde/1080/mpeg4” in this case) of a video content with a most suitable combination from the MIME type of the URI (“http://www.yyyyyyy.com/abcde/”) of the page introducing the video content of the specified video hosting site, and giving the server 3 an instruction to distribute (transmit) the video content, as described above. On this occasion, the URI (“http://www.yyyyyyy.com/abcde/”) of the video hosting site is, for example, recorded in the memory 33b.

The reference numeral 504 represents a step of transmitting, from the server 3 to the video display apparatus (reproduction apparatus) 1, the video content instructed to distribute (transmit).

In this manner, as described above with reference to FIGS. 3A-3D, the video display apparatus (reproduction apparatus) 1 can display the shared moving image in a form suitable for the video display apparatus (reproduction apparatus) 1. Thus, the user can enjoy the shared moving image in a viewing environment better than on the control apparatus (PC) 2. On this occasion, the display control of the shared moving image is moved from the control apparatus (PC) 2 to the video display apparatus (reproduction apparatus) 1. For example, display control of the moving image is operated by the user using the remote controller 18 of the video display (reproduction) apparatus (TV) 1.

In addition, the user can operate the remote controller 18 or the like as described above, to specify, on the shared moving image, a relevant shared moving image relevant to the shared moving image and change the display to display the relevant shared moving image.

On this occasion, the video display apparatus (reproduction apparatus) 1 receives the URI (“http://www.yyyyyyy.com/abcfg/”) of the page introducing the relevant moving image in the same manner as above mentioned.

Under the control of the controller 33, a suitable format and a suitable screen size are then decided so that a fine video display can be made using the video display capability or the like of the video display apparatus (reproduction apparatus) 1 itself stored in the memory 33b.

That is, as described above, the video display (reproduction) apparatus (TV) 1 gives the server 3 an instruction to transmit a relevant video hosting site suitable to the video display apparatus (reproduction apparatus) 1 based on an obtained URI (“http://www.yyyyyyy.com/abcfg/1080/mpeg4”).

The reference numeral 505 represents a step in which the video display apparatus (reproduction apparatus) 1 obtains a URI (“http://www.yyyyyyy.com/abcfg/1080/mpeg4”) of the relevant video content with a most suitable combination, based on the URI (“http://www.yyyyyyy.com/abcfg/”) of the specified relevant video hosting site, and gives the server 3 an instruction to distribute (transmit) the relevant video content.

As described above, that is, the video display apparatus (reproduction apparatus) 1 obtains a URI of the video content with a most suitable combination to be displayed on the video display apparatus (reproduction apparatus) 1 based on the MIME type of the URI (“http://www.yyyyyyy.com/abcde/” in this case) of the page introducing the video content in the specified video hosting site.

That is, here, the video display apparatus (reproduction apparatus) 1 analyzes data (for example, described in HTML format) obtained by access to the URI (“http://www.yyyyyyy.com/abcde/” shown in FIG. 2A) of the page introducing the video content, and obtains “http://www.yyyyyyy.com/abcde/1080/mpeg4” shown in FIG. 3A. Then, the video display apparatus (reproduction apparatus) 1 gives the server 3 a distribution instruction.

When the URI of the video content is obtained, an item list (for example, described in XML format) for the video content included in the page introducing the video content is, for example, acquired. Here, assume that information about resolution, format, title name, URI, etc. are described for each item in the item list.

The video display apparatus (reproduction apparatus) 1 selects each item the most suitable for display, from these pieces of information, and obtains a URI (“http://www.yyyyyyy.com/abcde/1080/mpeg4” in this case) of the video content based on the selected item.

On this occasion, the URI (“http://www.yyyyyyy.com/abcfg/”) of the page introducing the video content in the relevant video hosting site is, for example, recorded in the memory 33b.

The reference numeral 506 represents a step of transmitting, from the server 3 to the video display apparatus (reproduction apparatus) 1, the relevant video content instructed to distribute (transmit).

In the embodiment, to perform writing, the user moves an apparatus for performing a write control operation on a shared moving image (or relevant shared moving image) which is being displayed, from the video display (reproduction) apparatus (TV) 1 side to the control apparatus (PC) 2 side.

That is, the shared moving image (or relevant shared moving image) which is being displayed on the video display (reproduction) apparatus (TV) 1 is displayed on the control apparatus (PC) 2, and a writing 7 is performed on the shared moving image (or relevant shared moving image) using the keyboard of the control apparatus (PC) 2.

In this manner, writing can be performed on the shared moving image (or relevant shared moving image) using not the remote controller 18 of the video display (reproduction) apparatus (TV) 1 but the keyboard or the like of the control apparatus (PC) 2 which is comparatively easy to operate for writing.

Specifically, the user first uses the control apparatus (PC) 2 for writing, to give the video display (reproduction) apparatus (TV) 1 an instruction to transmit the URI (for example, “http://www.yyyyyyy.com/abcde/”) concerning the page introducing the video content of the shared moving image (or relevant shared moving image) which is being displayed.

The reference numeral 507 represents a step giving, from the control apparatus (PC) 2 to the video display (reproduction) apparatus (TV) 1, an instruction to transmit the URI concerning the page introducing the shared moving image (or relevant shared moving image) which is being displayed.

On this occasion, in this embodiment, as described above, the URI (“http://www.yyyyyyy.com/abcde/”) concerning the page introducing the shared moving image (or relevant shared moving image) which is being displayed is recorded in the memory 33b of the video display (reproduction) apparatus (TV) 1. Therefore, the transmission instruction can be achieved using the URI recorded in the memory 33b and concerning the page introducing the shared moving image (or relevant shared moving image) which is being displayed.

On receiving the instruction to transmit the URI (“http://www.yyyyyyy.com/abcde/”) concerning the page introducing the shared moving image (or relevant shared moving image) which is being displayed, the video display (reproduction) apparatus (TV) 1 transmits, to the control apparatus (PC) 2, the URI (“http://www.yyyyyyy.com/abcde/”) recorded in the memory 33b and concerning the page introducing the video content of the shared moving image (or relevant shared moving image) which is being displayed.

Here, description will be made on the URI concerning the page introducing the video content of the shared moving image (or relevant shared moving image).

DLNA Standards recommend that the URI (“http://www.yyyyyyy.com/abcfg/1080/mpeg4” in this case) per se of a moving image (or relevant moving image) is transmitted when an instruction to transmit the URI during the display of the moving image (or relevant moving image) is received. In this embodiment, however, the video display (reproduction) apparatus (TV) 1 transmits the URI (“http://www.yyyyyyy.com/abcfg/”) concerning a shared moving image (or relevant shared moving image) which is being displayed, in a format accessible by the control apparatus (PC) 2.

The format accessible by the control apparatus (PC) 2 will be described.

As described above, the URI is a URI of a shared moving image (or relevant shared moving image) when the shared moving image (or relevant shared moving image) is being displayed on the video display (reproduction) apparatus (TV) 1.

That is, the URI is, for example, expressed in a format of “http://www.yyyyyyy.com/abcde/1080/mpeg4” as shown in FIG. 3A or in a format of “http://www.yyyyyyy.com/abcfg/1080/mpeg4” as shown in FIG. 3C.

In these formats, the display capability of the video display (reproduction) apparatus (TV) 1 is taken into consideration so that a moving image can be displayed immediately. Thus, the formats are suitable for access from the video display (reproduction) apparatus (TV) 1.

However, for example, “1080/mpeg4” in each tail of the formats of the aforementioned URIs does not show the display capability of the control apparatus (PC) 2, and is not suitable for access from the control apparatus (PC) 2.

For this reason, when the URI concerning the shared moving image (or relevant shared moving image) which is being displayed is transmitted from the video display (reproduction) apparatus (TV) 1 to the control apparatus (PC) 2, a format suitable to access from the control apparatus (PC) 2, that is, the URI (“http://www.yyyyyyy.com/abcfg/”) of the page introducing a video content in the video hosting site of the shared moving image (or relevant shared moving image) which is being displayed is desired.

That is, in this embodiment, on receiving a URI transmission instruction from the control apparatus (PC) 2 during the display of a moving image (or relevant moving image) on the video display (reproduction) apparatus (TV) 1, the video display (reproduction) apparatus (TV) 1 transmits not the URI (“http://www.yyyyyyy.com/abcfg/1080/mpeg4”) of the moving image (or relevant moving image) which is being displayed but the URI (“http://www.yyyyyyy.com/abcfg/”) of the page introducing a video content in the video hosting site of the moving image (or relevant moving image) which is being displayed.

That is, in the aforementioned example, a URI such as “http://www.yyyyyyy.com/abcde/” or “http://www.yyyyyyy.com/abcfg/” is desired for the control apparatus (PC) 2.

The reference numeral 508 represents a step of transmitting, to the control apparatus (PC) 2, not a URI suitable for TV but a URI (“http://www.yyyyyyy.com/abcfg/” in this case) which is the most suitable for PC access.

The control apparatus (PC) 2 acquires the URI which is the most suitable for PC access, and gains access to the page introducing the video content in the video hosting site of the moving image (or relevant moving image) to perform writing.

In this embodiment, the URI of such a page introducing a video content in a video hosting site of a moving image (or relevant moving image) is a URI accessible by the control apparatus (PC) 2.

The reference numeral 509 represents a step of gaining access from the control apparatus (PC) 2 to a page where a comment can be made on the video content of the moving image which is being displayed (reproduced), and writing a comment thereon.

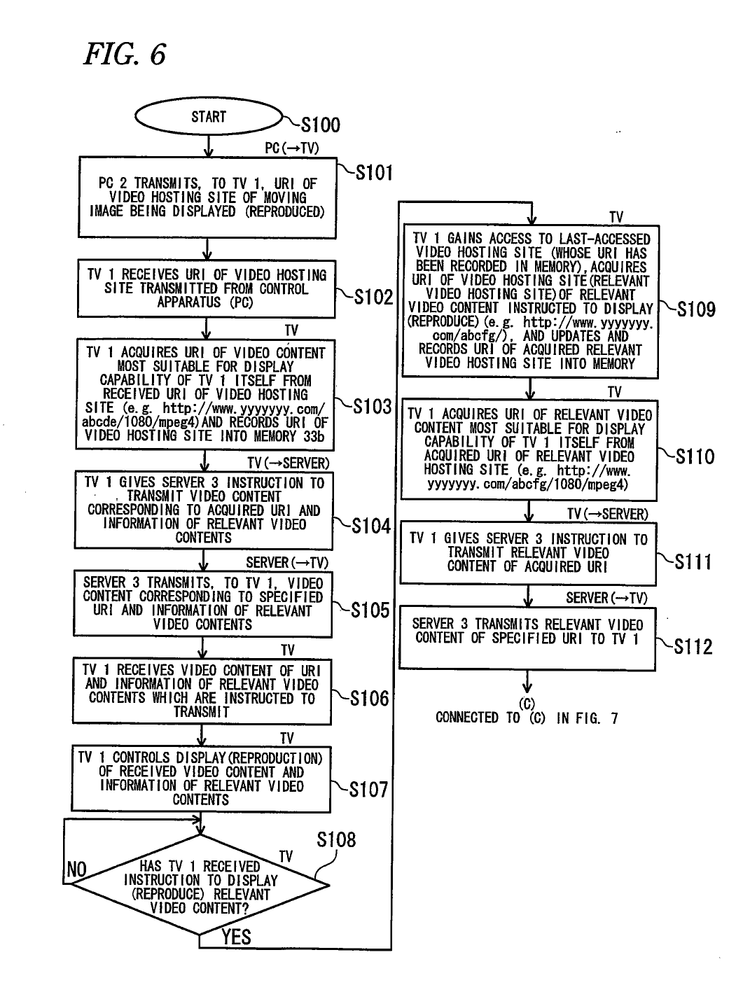

FIG. 6 shows the first half of a flow chart for explaining processing in the video display apparatus according to the embodiment.

Step S100 is a start step in the processing. Successively, the processing advances to Step S101.

In Step S101, the control apparatus (PC) 2 transmits, to the video display (reproduction) apparatus (TV) 1, a URI (“http://www.yyyyyyy.com/abcde/”) of a page introducing a video content in a video hosting site of a shared moving image which is being displayed (reproduced) on the control apparatus (PC) 2, in order to display the moving image on the video display (reproduction) apparatus (TV) 1. Successively, the processing advances to Step S102.

In Step S102, the video display (reproduction) apparatus (TV) receives the URI (“http://www.yyyyyyy.com/abcde/”) of the page introducing the video content in the video hosting site, which URI has been transmitted from the control apparatus (PC). Successively, the processing advances to Step S103.

In Step S103, the video display (reproduction) apparatus (TV) 1 obtains “http://www.yyyyyyy.com/abcde/1080/mpeg4”, which is the URI of the video content the most suitable for the display capability of the video display (reproduction) apparatus (TV) 1, from “http://www.yyyyyyy.com/abcde/” which is the received URI of the page introducing the video content in the video hosting site.

As described above, the video display apparatus (reproduction apparatus) 1 obtains the URI of the video content with a most suitable combination to be displayed on the video display apparatus (reproduction apparatus) 1, from the MIME type of the specified URI (“http://www.yyyyyyy.com/abcde/” in this case) of the page introducing the video content in the specified video hosting site.

That is, here, the video display apparatus (reproduction apparatus) 1 analyzes data (for example, described in HTML format) obtained by access to the URI (“http://www.yyyyyyy.com/abcde/” shown in FIG. 2A) of the page introducing the video content. Thus, the video display apparatus (reproduction apparatus) 1 obtains “http://www.yyyyyyy.com/abcde/1080/mpeg4” shown in FIG. 3A, and gives a distribution instruction to the server 3.

When the URI of the video content is obtained, for example, an item list (for example, described in XML format) for the video content included in the page introducing the video content is acquired. Here, assume that information including resolution, format, title name, URI, etc. are described for each item in the item list.

The video display apparatus (reproduction apparatus) 1 selects each item the most suitable for display, from these pieces of information, and obtains a URI (“http://www.yyyyyyy.com/abcde/1080/mpeg4” in this case) of the video content based on the selected item.

Here, “1080” designates the display size of the video transmitted from the URI of the video hosting site, and “mpeg4” designates a compression format with which the video content has been compressed. The URI of the video hosting site is recorded into the memory 33b of the video display (reproduction) apparatus (TV) 1. Successively, the processing advances to Step S104.

In Step S105, the video display (reproduction) apparatus (TV) 1 gives the server 3 an instruction to transmit a video content corresponding to the obtained URI (“http://www.yyyyyyy.com/abcde/1080/mpeg4”) and information of relevant video contents. Successively, the processing advances to Step S106.

In Step S106, the video display (reproduction) apparatus (TV) 1 receives the video content of the URI and the information of relevant video contents which are both instructed to transmit. Successively, the processing advances to Step S107.

In Step S107, the video display (reproduction) apparatus (TV) 1 controls the display (reproduction) of the received video content and the received information of relevant video contents. Successively, the processing advances to Step S108.

In Step S108, the video display (reproduction) apparatus (TV) 1 determines whether an instruction to display (reproduce) a relevant video content has been received or not. When it is concluded that an instruction to display (reproduce) a relevant video content has been received, the processing advances to Step S109 (Yes). When it is not concluded that an instruction to display (reproduce) a relevant video content has been received, the processing of Step S108 is repeated (No).

In Step S109, the video display (reproduction) apparatus (TV) 1 gains access to the last-accessed video hosting site so as to acquire the URI of a video hosting site (relevant video hosting site) of the relevant video content instructed to display (reproduce). On this occasion, as described above, the URI has been recorded in the memory. The URI is, for example, “http://www.yyyyyyy.com/abcfg/”. In addition, the acquired URI of the relevant video hosting site is updated and recorded into the memory 33b. Successively, the processing advances to Step S110.

In Step S110, as described above, the video display (reproduction) apparatus (TV) 1 acquires a URI of the relevant video content the most suitable for the display capability of the video display (reproduction) apparatus (TV) 1 itself from the acquired URI of the relevant video hosting site.

For example, the URI is “http://www.yyyyyyy.com/abcfg/1080/mpeg4”. Successively, the processing advances to Step S111.

In Step S111, the video display (reproduction) apparatus (TV) 1 gives the server 3 an instruction to transmit the relevant video content of the obtained URI (“http://www.yyyyyyy.com/abcfg/1080/mpeg4”). Successively, the processing advances to Step S112.

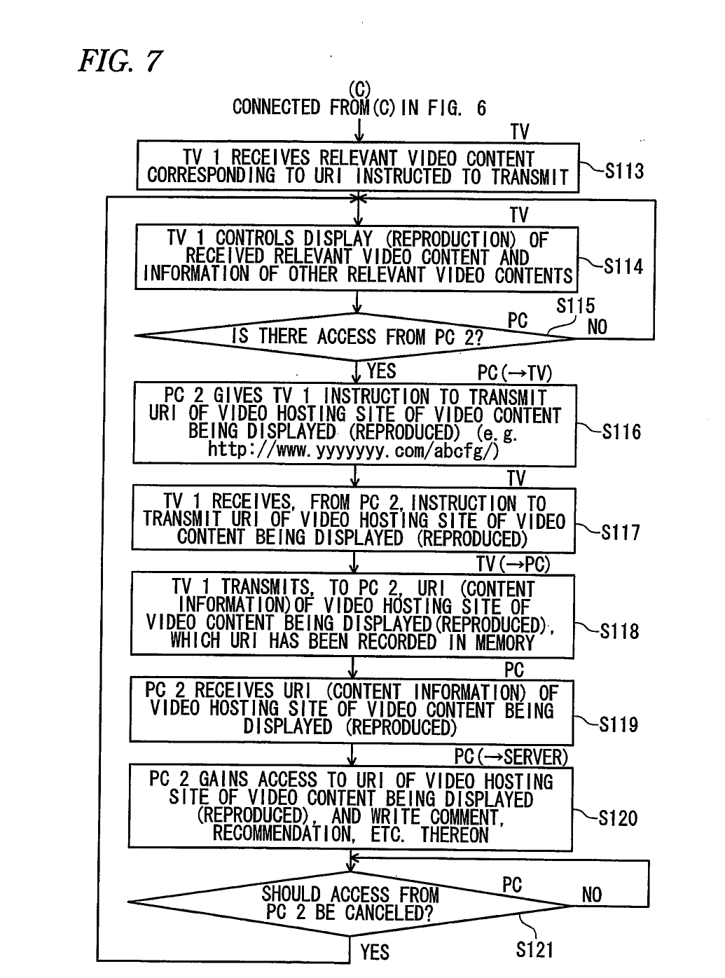

In Step S112, the server 3 transmits the relevant video content of the specified URI to the video display (reproduction) apparatus (TV) 1. Successively, the processing advances to Step S113 shown in FIG. 7.

FIG. 7 shows the second half of the flow chart for explaining the processing in the video display apparatus according to the embodiment.

In Step S113, the video display (reproduction) apparatus (TV) 1 receives the relevant video content corresponding to the URI instructed to transmit. Next, the processing advances to Step S114.

In Step S114, the video display (reproduction) apparatus (TV) 1 controls display (reproduction) of the received relevant video content and information of other relevance video contents. Next, the processing advances to Step S115.

In Step S115, as described above, the user operates the control apparatus (PC) 2 to determine whether to gain access to the moving image (or relevant moving image) from the control apparatus (PC) 2 or not, in order to perform writing or the like. When it is concluded to gain access to the moving image (or relevant moving image) from the control apparatus (PC) 2, the processing advances to Step S116 (Yes). When it is not concluded to gain access to the moving image (or relevant moving image) from the control apparatus (PC) 2, the processing returns to Step S114 to repeat the aforementioned processing (No).

In Step S116, the control apparatus (PC) 2 gives the video display (reproduction) apparatus (TV) an instruction to transmit the URI of the video hosting site of the video content which is being displayed (reproduced). The URI here is, for example, “http://www.yyyyyyy.com/abcfg/”. Next, the processing advances to Step S117.

In Step S117, the video display (reproduction) apparatus (TV) 1 receives, from the control apparatus (PC) 2, the instruction to transmit the URI of the video hosting site of the video content which is being displayed (reproduced). Next, the processing advances to Step S118.

In Step S118, the video display (reproduction) apparatus (TV) 1 transmits, to the control apparatus (PC) 2, the URI (“http://www.yyyyyyy.com/abcde/”) of the page introducing the video content in the video hosting site of the video content which is being displayed (reproduced), which URI has been recorded in the memory. Successively, the processing advances to Step S119.

In Step S119, the control apparatus (PC) 2 receives the URI (content information) of the video hosting site of the video content which is being displayed (reproduced). Successively, the processing advances to Step S120.

In Step S120, in response to user's operation, the control apparatus (PC) 2 gains access to the URI of the video hosting site of the video content which is being displayed (reproduced), and allows the user to write a comment, a recommendation, or the like. Successively, the processing advances to Step S121.

In Step S121, it is determined whether to cancel the access from the control apparatus (PC) 2 or not, for example, in order to move the display (reproduction) of the shared moving image back onto the video display (reproduction) apparatus (TV) 1. When it is concluded to cancel the access from the control apparatus (PC) 2, the processing returns to Step S114 to repeat the aforementioned processing (Yes). When it is not concluded to cancel the access from the control apparatus (PC) 2, the access from the control apparatus (PC) 2 is kept on (No).

In this embodiment, which is configured as described above, the video hosting service can be used in the video display (reproduction) apparatus (TV) 1 as well as in the control apparatus (PC) 2 or the like.

In addition, a write operation concerning the moving image can be performed on the video display (reproduction) apparatus (TV) 1 in the same manner as on the control apparatus (PC) 2 or the like. It is therefore possible to reduce troubles the user may feel when the user performs a write operation on the video display (reproduction) apparatus (TV) 1.

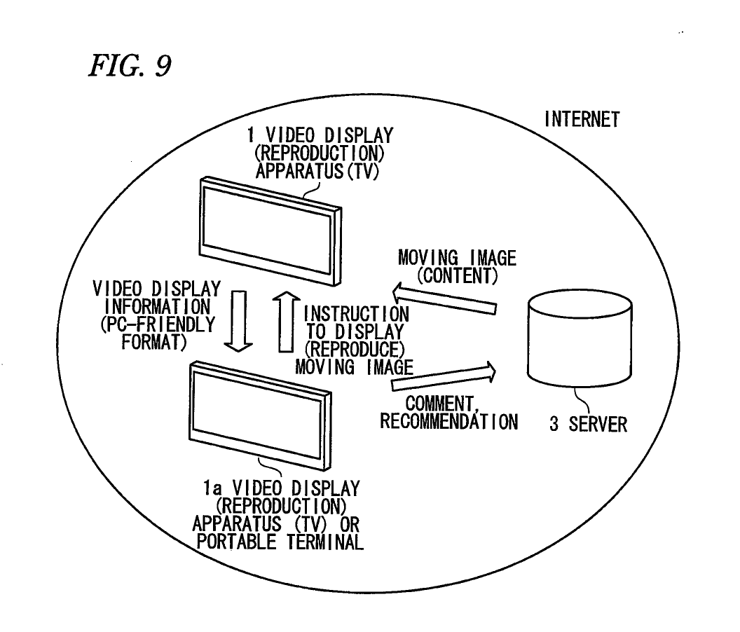

FIG. 9 illustrates another example of an example of a video hosting service using a video display apparatus according to the embodiment.

The reference numeral 1a represents another video display (reproduction) apparatus (TV).

In the aforementioned description, description has been made using a PC as an example of the control apparatus 2. In this embodiment, as shown in FIG. 9, the other video display (reproduction) apparatus (TV) 1a may be used as the control apparatus 2 in the aforementioned description so as to perform an operation similar to the aforementioned operation.

On this occasion, it is desired that the other video display (reproduction) apparatus (TV) 1a is easier than the aforementioned video display (reproduction) apparatus (TV) 1 in view of operation such as writing.

In addition, an apparatus easy in operation such as writing, such as a portable terminal or a cellular phone, may be used as the video display (reproduction) apparatus (TV) 1a.

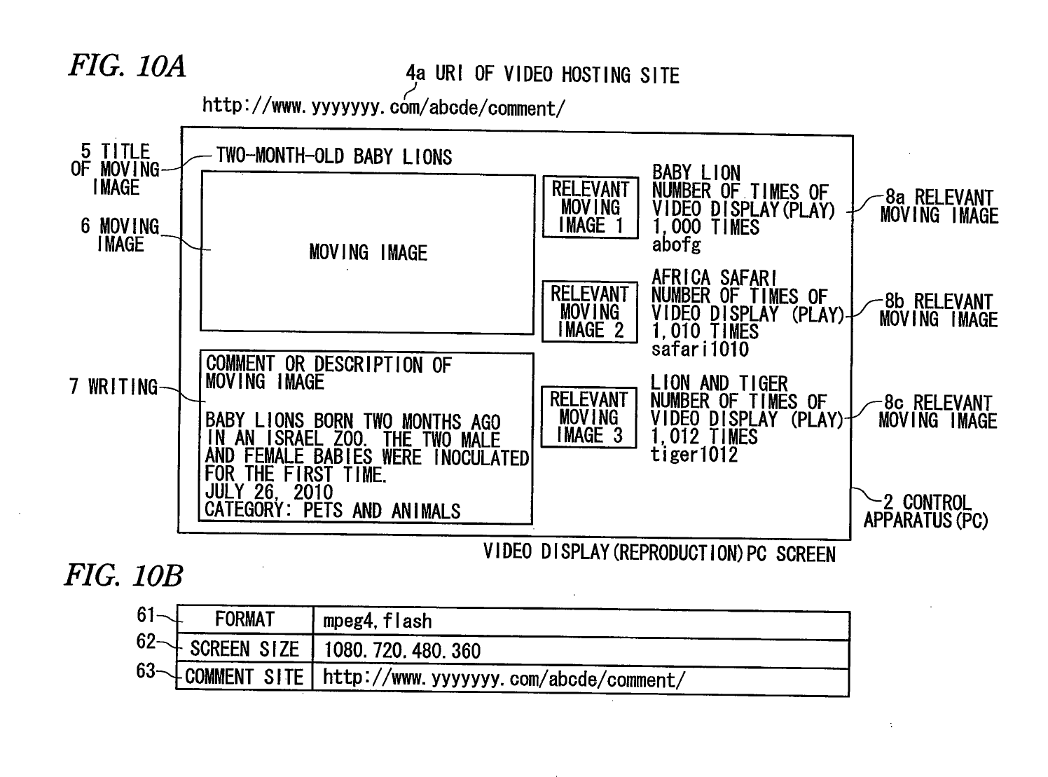

FIGS. 10A and 10B illustrate another example of a display screen when the control apparatus (PC) receives a URI of a video hosting site concerning a first moving image, according to the embodiment.

FIG. 10A is a view showing a display screen of the control apparatus (PC) 2.

Here, a video display module (video display (reproduction) PC screen) of the control apparatus (PC) 2 is depicted.

The reference numeral 4b represents a URI of a writing site where a user or the like can write on a shared moving image. The URI 4b is “http://www.yyyyyyy.com/abcde/comment/” here.

Here, the writing 7 is “Baby lions born two months ago in an Israel zoo. The two male and female babies were inoculated for the first time. Jul. 26, 2010 Category: Pets and Animals”.

FIG. 10B illustrates plural formats with which moving images can be transmitted from the video hosting site.

The reference numeral 63 represents a URI of the writing site of the shared moving image. Here, the URI “http://www.yyyyyyy.com/abcde/comment/” of the writing site of the shared moving image can be acquired from the URI “http://www.yyyyyyy.com/abcde/” of the video hosting site.

The control apparatus (PC) 2 receives the URI (“http://www.yyyyyyy.com/abcde/comment/”) of the writing site of the shared moving image, which URI is different from the URI “http://www.yyyyyyy.com/abcde/” of the page introducing the video content of the shared moving image. Thus, the control apparatus (PC) 2 is allowed to perform writing on the shared moving image.

The aforementioned embodiment is not limited to its description as it is. Constituent elements may be modified without departing from the scope of the invention.

1. A video display apparatus, comprising:
a display controller configured to cause a display module to display a moving image distributed from a video hosting site, the moving image having a first URI; and
a URI output module configured to output a second URI different from the first URI, upon receiving a URI transmission request during display of the moving image.

2. The apparatus of claim 1,
wherein the second URI corresponds to a page introducing a video content in the video hosting site.

3. The apparatus of claim 1,
wherein the second URI corresponds to a page where writing on a shared moving image is allowed.

4. The apparatus of claim 1,
wherein the URI transmission request is outputted from another apparatus, and
wherein the URI output module outputs the second URI in response to the URI transmission request.

5. The apparatus of claim 1, further comprising:
a URI receiver configured to receive a URI of a video hosting site, the video hosting side providing a first moving image with plural screen size formats; and
a specifying module configured to specify at least one of the screen size formats with which the first moving image is to be outputted, based on the URI of the video hosting site,
wherein the first moving image is displayed with the specified moving image output format.

6. The apparatus of claim 5,
wherein the received video hosting site includes information about a relevant video hosting site different from the video hosting site, the relevant video hosting site providing a second moving image relevant to the first moving image.

7. The apparatus of claim 5, further comprising:
a URI recorder configured to record, during display of the first moving image, the URI of the video hosting site corresponding to the first moving image.

8. The apparatus of claim 5, further comprising:
a URI recorder configured to record, during display of the first moving image, the URI of the video hosting site corresponding to the first moving image,
wherein the recorded URI is outputted, upon receiving a URI transmission request outputted from another apparatus.

9. The apparatus of claim 1, further comprising;
the display module.

10. A video display method, comprising:
displaying, on a display module, a moving image distributed from a video hosting site, the moving image having a first URI; and
outputting a second URI different from the first URI, upon receiving a URI transmission request during display of the moving image.
